(19) United States
(12) Patent Application Publication
(10) Pub. No.: US 2009/0010120 A1
(43) Pub. Date: Jan. 8, 2009

(54) SYSTEM AND METHOD FOR DYNAMIC BUFFER MANAGEMENT BY MONITORING DATA BUFFERING STATUS

(76) Inventors: Yen-Cheng Lin, Kao-Hsiung City (TW); Shih-Hsin Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/773,964

(22) Filed: Jul. 6, 2007

(51) Int. Cl. G11B 19/12

(52) U.S. Cl. 369/47.29

(57) ABSTRACT

An optical storage system, for dynamically controlling the rate of recording data to an optical medium includes: a buffer, for buffering data to be recorded to the optical medium; a data recording block, coupled to the buffer and the optical medium, for recording data from the buffer to the optical medium at a recording speed; and a control block, coupled to the buffer and the data recording block, for monitoring an amount of data buffered in the buffer, and adjusting the recording speed by comparing at least one criteria with the amount of data buffered in the buffer.

### BACKGROUND

A conventional data recording system utilizes a buffer for temporarily storing data to be recorded. Data is sent from a host and recorded to an optical medium at a recording speed. A data recording apparatus, coupled between the buffer and the optical medium, controls the recording speed.

If the recording speed is too low then the buffer will quickly reach maximum capacity, preventing more data from being stored. That is, a buffer overflow occurs. If the recording speed is too high, however, the buffer will completely empty before more data can be stored. In other words, a buffer underflow occurs. In such a case, the recording process will have to be temporarily paused until more data is input to the buffer. When recording is resumed, to ensure that there is no discrepancy between previously recorded data and currently recorded data, a super-link signal needs to be burned onto the optical disc. The signal links the end of previously recorded data with the start of currently recorded data. Therefore, the greater the number of super-link signals are burnt, the greater the possibility of there being recording discrepancies. Furthermore, the utilization of super-link signals and the pausing and/or restarting the recording process reduces the overall recording efficiency. Therefore, it is beneficial to provide a system that could prevent buffer empty and/or buffer full situations from occurring.

### SUMMARY

With this in mind, a system for reducing the amount of super-link signals needed during a data recording process by reducing or preventing the occurring frequency of buffer empty events is provided. Furthermore, the system also reduces the occurring frequency of buffer full events.

An optical storage system is disclosed. The optical storage system comprises: a buffer, for buffering data to be recorded to an optical medium; a data recording block, coupled to the buffer and the optical medium, for recording data from the buffer to the optical medium according to at least one recording adjustment parameter; and a control block, coupled to the buffer and the data recording block, for monitoring an amount of data buffered in the buffer, and adjusting at least one criteria with the amount of data buffered in the buffer.

A method for dynamically controlling the rate of recording data to an optical medium is also disclosed. The method includes the following steps: buffering data to be recorded to the optical medium in a buffer; recording the buffered data to the optical medium according to at least one recording adjustment parameter; monitoring an amount of data buffered in the buffer; and comparing at least one criteria with the amount of data buffered in the buffer to adjust at least the recording adjustment parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an optical storage system according to an embodiment of the present invention.

FIG. 2 is a flowchart of a first embodiment of the present invention.

FIG. 3 is a flowchart of a second embodiment of the present invention.

### DETAILED DESCRIPTION

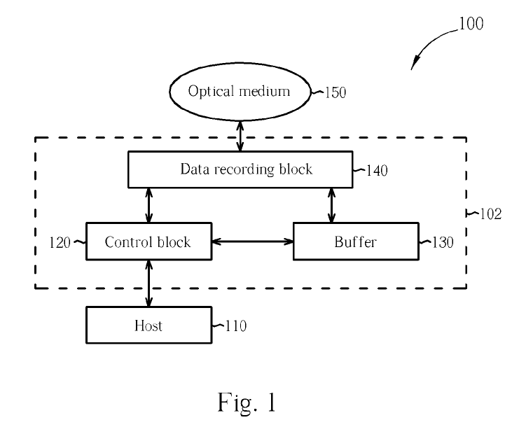

Please refer to FIG. 1. FIG. 1 is a diagram of an optical storage system 100 according to an embodiment of the present invention. The optical storage system 100 comprises an optical medium 150; a data recording block 140 coupled to the optical medium 150; a buffer 130 coupled to the data recording block 140; a control block 120 coupled to the data recording block 140 and the buffer 130; and a host 110 coupled to the control block 120. In the embodiment shown in FIG. 1, the data recording block 140, the buffer 130, and the control block 120 are disposed in an optical storage apparatus 102 (e.g. an optical disc drive) used for accessing data on the optical medium 150 (e.g. an optical disc), but the disclosed optical storage system is not limited to this configuration. It should be noted that the data recording block 140 includes any components required for accessing data on the optical medium 150. For instance, the data recording block 140 includes an optical pick-up head, a spindle motor, a servo control system, etc. During a data recording request, data is sent from the host 110 and buffered in the buffer 130 before being recorded to the optical medium 150.

In a first embodiment the control block 120 is utilized for controlling the data recording block 140 to adjust at least one record adjustment parameter by comparing at least one criteria with an amount of data buffered in the buffer 130. In this embodiment, the record adjustment parameter represents a recoding speed controlled by the data recording block 140. Initially, data is transmitted from the host 110 to the buffer 130, and then recorded to the optical medium 150 at the recording speed. The control block 120 continuously monitors a data level of the buffer 130. Two criteria are defined by the control block 120: the first criterion is a low data level situation of the buffer 130, and the second criterion is a high data level situation of the buffer 130. Please note that the low data level situation and the high data level situation can be altered according to design requirements. For example, the low data level situation could be a buffer empty situation, a low level of data buffered in the buffer is met, or a plurality of buffer empty situations, i.e. a buffer empty situation has occurred a defined number of times. Similarly, the high data level situation could be a buffer full situation, a high level of data buffered in the buffer is met, or a plurality of buffer full situations, i.e. a buffer full situation has occurred a defined number of times. For simplicity, the following description will take a data low situation as the low data level and a data high situation as the high data level

When the control block 120 monitors that a data low level situation has occurred, the control block 120 will control the data recording block 140 to reduce the recording speed. This ensures that data will not leave the buffer 130 too fast. The control block 120 then monitors the buffer 130 for a data high level situation. If a data high level situation occurs then the control block 120 will control the data recording block 140 to increase the recording speed. In turn, this enables the buffer 130 to empty data faster, thereby preventing the high data level situation from occurring.

By continuously monitoring the data level of the buffer 130, the control block 120 can avoid a situation requiring a super-link signal to be burnt to the optical medium 150, thereby improving the quality of the recorded data. Furthermore, data recording efficiency can be improved, by ensuring a buffer full or empty event does not occur.

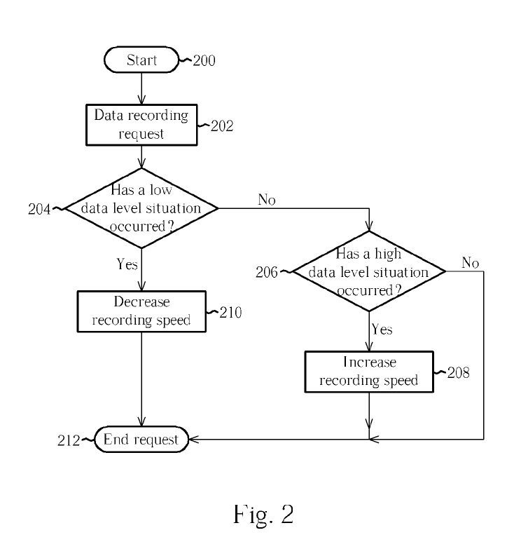

Please refer to FIG. 2. FIG. 2 is a flowchart of a method corresponding to the above-described system. The steps are as follows:
Step 200: Start;
Step 202: Data recording request;
Step 204: Has a low data level situation occurred? If yes go to Step 210, if no go to Step 206;
Step 206: Has a high data level situation occurred? If yes go to Step 208, if no go to Step 212;
Step 208: Increase recording speed and go to Step 212;
Step 210: Decrease recording speed and go to Step 212;
Step 212: End request.

Please refer to FIGS. 1 and 2. The process begins (Step 200) and a data recording request is issued (Step 202). Data is sent from the host 110, buffered in the buffer 130, and recorded to the optical medium 150 at an optimum recording speed. The control block 120 monitors the data level of the buffer 130, utilizing predetermined ‘low level’ and ‘high level’ values as parameters. If the amount of the data buffered in the buffer 130 equals or is less than the low level value, i.e. a low data level situation has occurred (Step 204) then the control block 120 will control the data recording block 140 to decrease the recording speed (Step 210). If the low data level situation has not occurred but a high level event has occurred (Step 206), i.e. the amount of the data buffered in the buffer 130 equals or exceeds the high level value, then the control block 120 will increase the recording speed (Step 208). Thereafter the process ends (Step 212).

The control block 120 can also utilize the data level of the buffer 130 to control other factors related to data recording, for ensuring a buffer empty or a buffer full event does not occur. In another embodiment of the present invention, the recording adjustment parameter represents a record start threshold determining when to begin data recording. The control block 120 monitors the data level of the buffer 130 to control the record start threshold.

Initially when data is stored in the buffer 130, the optical storage apparatus 102 will not immediately start recording the data from the buffer 130 to the optical medium 150. Instead, the process starts when the data level reaches a predetermined level, known as the record start threshold. This is the minimum amount of data required in the buffer 130 for starting the recording to disc process. If the record start threshold is set too high, and the recording speed of recording data to disc is not fast enough, a buffer full event will occur easily. Similarly, if the data record threshold is set too low, and the recording speed of recording data to disc is set too high, then a buffer empty event will easily occur. By altering the record start threshold rather than the recording speed the control block 120 can also reduce the occurring frequency of both buffer full and buffer empty events.

When the control block 120 monitors that a low data level situation has occurred then the control block 120 will increase the record start threshold. This allows more data to enter and be stored in the buffer 130 without being instantly recorded to the optical medium 150. The control block 120 then monitors the buffer 130 for a high data level situation. If a high data level situation occurs then the control block 120 will decrease the record start threshold. This allows a greater quantity of data in the buffer 130 to be recorded to the optical medium 150, thereby working to reduce the amount of data in the buffer 130 at any particular time.

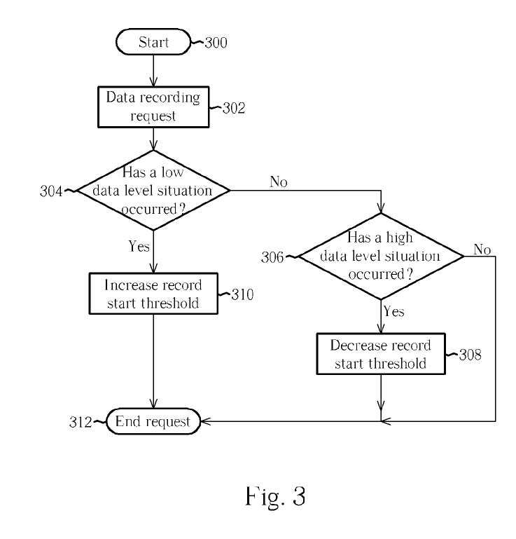

Please refer to FIG. 3. FIG. 3 is a flowchart of the method of utilizing the data in the buffer 130 to alter the record start threshold.
Step 300: Start;
Step 302: Data recording request;
Step 304: Has a low data level situation occurred? If yes go to Step 310, if no go to Step 306;
Step 306: Has a high data level situation occurred? If yes go to Step 308, if no go to Step 312;
Step 308: Decrease the record start threshold and go to Step 312;
Step 310: Increase the record start threshold and go to Step 312;
Step 312: End request.

Referring to FIGS. 1 and 3, the process begins (Step 300) and a data recording request is issued (Step 302). Data is sent from the host 110, buffered in the buffer 130, and recorded to the optical medium 150 at an optimum recording speed. The control block 120 monitors the data level of the buffer 130, utilizing predetermined ‘low level’ and ‘high level’ values as parameters. If the amount of the data buffered in the buffer 130 equals or is less than the low level value, i.e. a low data level situation has occurred (Step 304) then the control block 120 will increase the record start threshold (Step 310). If a low data level situation has not occurred but a high data level situation occurs (Step 306), i.e. the amount of the data buffered in the buffer 130 equals or exceeds the high level value then the control block 120 will decrease the record start threshold (Step 308). Thereafter the process ends (Step 312).

By monitoring the data level of the buffer 130, the control block 120 can determine when a low data level situation or a high data level situation is about to occur. The control block 120 can then utilize this result to adjust a recording rate of the buffer 130 to the optical medium 150, by controlling the amount of data in the buffer 130, and thereby reducing or preventing the occurrence of buffer empty and buffer full events.

Please note that in the above embodiments illustrated in FIG. 2 and FIG. 3, both the low data level situations and high data level situations are monitors or detectors. This is not meant to be a limitation of the present invention, however. Any designs that control the recording speed/record start threshold through monitoring either low data level situations or high data level situations still obey the spirit of the present invention and fall in the scope of the present invention. Moreover, the control block in the present invention can also adjust both the recording speed and the record start threshold simultaneously by controlling the data recording block and the buffer respectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical storage system, for dynamically controlling the rate of recording data to an optical medium, the optical storage system comprising:
a buffer, for buffering data to be recorded to the optical medium;
a data recording block, coupled to the buffer and the optical medium, for recording data from the buffer to the optical medium according to at least one recording adjustment parameter; and
a control block, coupled to the buffer and the data recording block, for monitoring an amount of data buffered in the buffer, and adjusting at least the recording adjustment parameter by comparing at least one criterion with an amount of data buffered in the buffer.

2. The optical storage system of claim 1, wherein the criterion is a low data level situation.

3. The optical storage system of claim 2, wherein the low data level situation is a buffer empty situation, a low level of data in the buffer is met, or a number of times a buffer empty situation occurs, wherein the number of times is a first predetermined value.

4. The optical storage system of claim 2, wherein the recording adjustment parameter represents a recording speed controlled by the data recording block.

5. The optical storage system of claim 4, wherein when the amount of data buffered in the buffer reaches the low data level situation, the control block controls the data recording block to decrease the recording speed.

6. The optical storage system of claim 5, wherein the control block adjusts the recording speed until a predetermined minimum recording speed is achieved.

7. The optical storage system of claim 2, wherein the recording adjustment parameter represents a record start threshold determining when to begin data recording.

8. The optical storage system of claim 7, wherein when the amount of data buffered in the buffer reaches the low data level situation, the control block increases the record start threshold.

9. The optical storage system of claim 1, wherein the criterion is a high data level situation.

10. The optical storage system of claim 7, wherein the high data level situation is a buffer full situation, a high level of data in the buffer is met, or a number of times a buffer full situation occurs, wherein the number of times is a second predetermined value.

11. The optical storage system of claim 9, wherein the recording adjustment parameter represents a recording speed controlled by the data recording block.

12. The optical storage system of claim 1 1, wherein when the amount of data buffered in the buffer reaches the high data level situation, the control block controls the data recording block to increase the recording speed.

13. The optical storage system of claim 9, wherein the recording adjustment parameter represents a record start threshold determining when to begin data recording.

14. The optical storage system of claim 13, wherein when the amount of data buffered in the buffer reaches the high data level situation, the control block decreases the record start threshold.

15. The optical storage system of claim 14, wherein the control block adjusts the record start threshold until a predetermined minimum record start threshold is achieved.

16. A method of dynamically controlling the rate of recording data to an optical medium, the method comprising:
buffering data to be recorded to the optical medium in a buffer;
recording the buffered data to the optical medium according to at least one recording adjustment parameter;
monitoring an amount of data buffered in the buffer; and
comparing at least one criterion with the amount of data buffered in the buffer to adjust at least the recording adjustment parameter.

17. The method of claim 16, wherein the criterion is a low data level situation.

18. The method of claim 17, wherein the low data level situation is a buffer empty situation, a low level of data in the buffer is met, or a number of times a buffer empty situation occurs, wherein the number of times is a first predetermined value.

19. The method of claim 17, wherein the recording adjustment parameter represents a recording speed for recording data from the buffer to the optical medium.

20. The method of claim 19, further comprising:
decreasing the recording speed when the amount of data buffered in the buffer reaches the low data level situation.

21. The method of claim 17, wherein the recording adjustment parameter represents a record start threshold for determining when to begin data recording.

22. The method of claim 21, further comprising:
increasing the record start threshold when the amount of the data buffered in the buffer reaches the low data level situation.

23. The method of claim 1 6, wherein the criterion is a high data level situation.

24. The method of claim 23, wherein the high data level situation is a buffer full situation, a high level of data in the buffer is met, or a number of times a buffer full situation occurs, wherein the number of times is a second predetermined value.

25. The method of claim 23, wherein the recording adjustment parameter represents a recording speed for recording data from the buffer to the optical medium.

26. The method of claim 25, further comprising:
increasing the recording speed when the amount of data buffered in the buffer reaches the high data level.

27. The method of claim 23, wherein the recording adjustment parameter represents a record start threshold for determining when to begin data recording.

28. The method of claim 27, further comprising:
decreasing the recording speed when the amount of data buffered in the buffer reaches the high data level.
